(19) United States
(12) Patent Application Publication
(10) Pub. No.: US 2012/0261892 A1
(43) Pub. Date: Oct. 18, 2012

(54) SLEDGE

(76) Inventor: Reto GIRSBERGER, Eglisau (CH)

(21) Appl. No.: 13/474,414

(22) Filed: May 17, 2012

Related U.S. Application Data
(63) Continuation of application No. PCT/EP2010/066380, filed on Oct. 28, 2010.

(30) Foreign Application Priority Data
Nov. 24, 2009 (CH) 2009CH-1804

(51) Int. Cl. B62B 13/08

(52) U.S. Cl. 280/16

(57) ABSTRACT

The invention relates to a sledge (1) having a plurality of segments (1a, 1b, 1c) connected to one another. Each segment (1a, 1b, 1c) has at least one runner (3a). A flexible, central holding element is led through all segments (1a, 1b, 1c) through an opening.

### RELATED APPLICATIONS

This application is a continuation of PCT/EP2010/066380, filed Oct. 28, 2010, which claims priority to 2009CH-1804, filed Nov. 24, 2009, the entire contents of which are hereby incorporated by reference.

### FIELD OF THE INVENTION

The invention refers to a sledge which consists of a plurality of segments corresponding to the introductory portion of the independent claim.

### DESCRIPTION OF THE RELATED ART

Sledges which comprise several segments are already known in the state of the art. FR27421177 and CH521258 disclose gliding boards which consist of several serially coupled segments.

U.S. Pat. No. 6,834,867 discloses a snowboard which consists of two segments. U.S. Pat. No. 7,100,927 discloses a steered sledge which comprises also two segments. U.S. Pat. No. 4,262,919 discloses a similar steered sledged which comprises two segments and on which two persons have room.

DE3242913 describes a deformable sports equipment device which can be arranged in a fixed or flexible structure and changed therebetween. This is achieved by one or more free-range sections which lead through connection elements to the configurable and gradable tension device.

### SUMMARY OF THE INVENTION

It is object of the present invention to provide a sledge with a plurality of segments which has an improved mechanical connection and an improved flexibility between the single segments and thus, permits a more precise control.

According to the invention, this object is achieved by a sledge according to the introductory portion of the independent claim which is characterized in that a flexible, central holding element is guided through an opening within all segments.

Further advantageous embodiments are referred to in the dependent claims.

The flexible, central holding element could consist for example of any flexible material like fiber glass, plastic or metal and could be single-phase or multi-phase. In addition, a cone could be arranged at the border of the segments, wherein a spring is arranged between the single segments, respectively, wherein the spring is wound around the holding element and presses the cones in stud holes which are arranged in the segments. A distance maintaining means at which cones are fixed could be led through the segments arranged at the end. The cones at the ends are carried out closed, the inner cones are carried out open such that holding element can be fed through the inner cones. A good mechanical support of the sledge is given through the flexible, central holding element provides, wherein the single segments are well movable at the same time (torsion movement).

The segments could comprise coupling means like hooks in order to connect one segment with the subsequent segment. The hooks are hooked in a loop of the following segment.

The segments could comprise three runners, wherein two runners are arranged at the lateral border of a segment and one runner is arranged centrally. The external runners serve for the control, while the central runner distributes the weight on the ground. The opening which is fed advantageously centrally in the middle through the segments is arranged above the central runner.

The runners are exchangeably fixed at the segments. Thus, it is possible to mount runners with different width or even wheels at the segments. An application on the water by the means of gliding means like a flexible mesh or inflexible blades which are fixed instead of the runners is also possible.

### BRIEF DESCRIPTION OF THE DRAWINGS

The invention will be described in more detail by means of the attached drawings, wherein

FIG. 1 shows a top view of the sledge of the invention which consists of segments;

FIG. 2 shows a view of the sledge according to the invention from below;

FIG. 3 shows a perspective view of the sledge according to the invention;

FIG. 4 shows a view of the sledge according to the invention from the front; and

FIG. 5 shows the flexible central holding element which is according to the invention fed through an opening through the single segments.

### DETAILED DESCRIPTION OF THE PREFERRED EMBODIMENTS

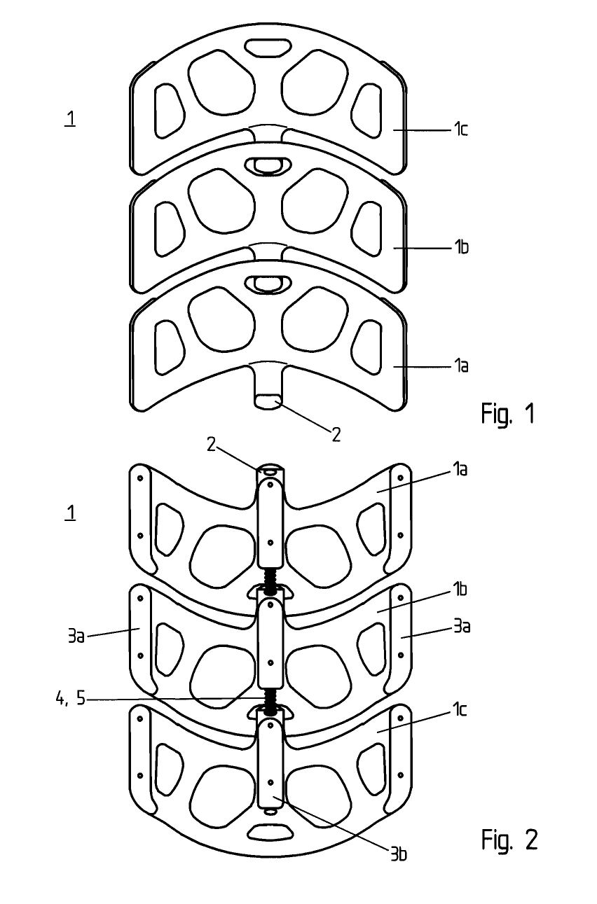

The sledge 1 according to the invention is shown in a view from above in FIG. 1. The sledge 1 consists of a plurality of segments 1a, b, c which are connected with each other by hooks 2 or other coupling means. The hook 2 which is hooked in an opening of the next segment, respectively, is arranged at one end of a segments 1a, b, c. This kind of connection allows a movement between the single segments 1a, b, c as with a hinge. Only three segments are shown. However, the sledge 1 according to the invention is modular and can be varied in the length by the chosen number of segments 1a, b, c. The movement of the single elements among each other allows a continuous contact with the ground by the runners 3 of all segments 1a, b, c and thus, increases the directional stability and favors the precise controllability. The segments 1a, b, c could for example be manufactured by rotation sintering or by injection molding. Single sledges (of several persons) for example could be coupled to each other during the travel by the means of the hooks. However, if an exceeded advance movement takes place from behind, the sledges decouple automatically. Therefore, the risk of accidents is reduced.

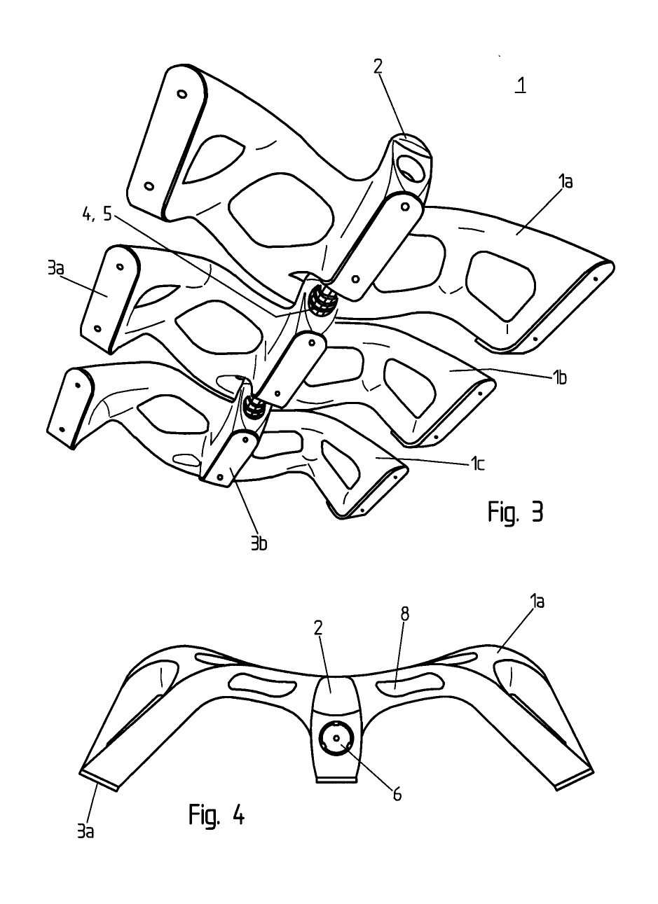

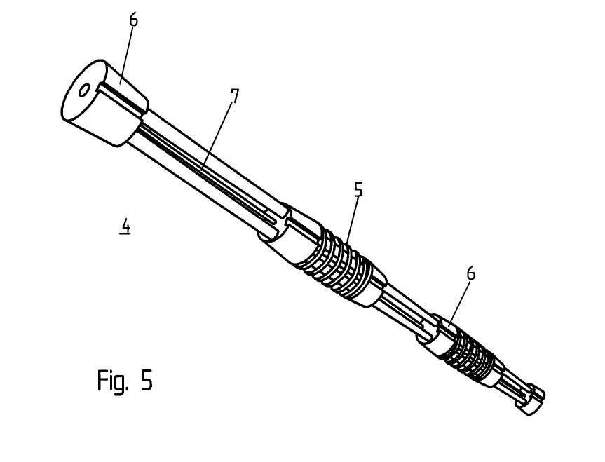

FIG. 2 shows the view of the sledge 1 according to the invention from below and FIG. 3 a perspective view of the sledge 1 according to the invention from below. Each segment 1a, b, c comprises three runners 3a, b. Thereby at each segment 1a, b, c at each lateral border a lateral runner 3a a central runner 3b is arranged. The external runners 3a serve the controllability, while the central runner 3b distributes the weight on the ground. According to the invention, a flexible, central holding element 4 is provided in an opening which is led through all segments 1a, b, c. The opening is centrally in the middle led through the segments 1a, b, c and is arranged above the central runner 3b. A spring 5 which is wound around the holding element 4 is provided between the segments 1a, b, c, respectively. The spring 5 presses at the border of the segments 1a, b, c a cone 6 in a corresponding stud hole, respectively that is arranged at the single segments 1a, b, c. The holding element 4 with springs 5 and cones 6 are shown in FIG. 5. In the shown embodiment, the holding element 4 has three phases which provide a good stability and adequate flexibility. However, the number of the phases can vary according to the material and the embodiment. The inner cones 6 are carried out open such that the continuous holding element 4 can be fed through, while the external cones 6 are carried out closed. FIG. 4 shows a view of the sledge according to the invention from the front, wherein the final cone 6 is visible. In another embodiment, there are not provided cones anymore and the holding means of the holding elements 5 are directly provided in the segment 1a, b, c.

As shown in FIG. 5, distance maintaining means 7 which is provided within the single phases is provided at the segments provided at the end. The external cone 6 which is visible in FIG. 4 is fixed at the distance maintaining means 7 e.g. screwed. The distance maintaining means 7 consists e.g. of an aluminum rod. The cones 6 have a twist protection in the form that they show grooves distributed over the circumference. The stud holes which are arranged in the segments have corresponding forms which engage in the grooves.

Furthermore, a number of reflectors 8 are arranged distributed on the sledge as shown e.g. in FIG. 4. It is also possible to produce the segments 1a, b, c by a fluorescent material. The runners 3 are fixed in an exchangeable manner. Thus, it is possible to mount runners 3a, b in different width or even wheels (not shown) at the segments 1a, b, c. For the use on water instead of runners 3a, b a flexible mesh between the runners 3a, b or inflexible blades are arranged at the segments. Thus, the sledge can be brought to glide. The runners a, b could e.g. be screwed at the segments 1a, b, c.

### Reference List

1 Sledge
1a, b, c Segments of the sledge 1
2 Hook
3a External runner
3b Inner runner
4 Holding element
5 Spring
6 Cone
7 Distance maintaining means
8 Reflector

1. A sledge comprising: a plurality of serially coupled segments, wherein each segment comprises at least one runner independent from the at least one runner of the other segments, and a flexible, central holding element led through an opening through all segments.

2. The sledge according to claim 1, wherein the holding element is one- or multiple-phase and is made of fibre glass, plastic or metal.

3. The sledge according to claim 1, wherein a cone is provided at the border at each segment, respectively, and that a spring which is wound around the holding element and presses the cones in stud holes provided in the segments is provided between the single segments, respectively.

4. The sledge according to claim 1, wherein distance maintaining means at which lateral cones are provided is led through the segments arranged at the end.

5. The sledge according to claim 1, wherein the segments comprise three runners, wherein two runners are provided at the lateral border of the segments and one runner is arranged centrally.

6. The sledge according to claim 1, wherein the segments comprise three runners, wherein external runners serve for the controllability and the central runner distributes the weight on the ground.

7. The sledge according to claim 1, wherein the segments comprise coupling means in order to connect a segment with the following segment.

8. The sledge according to claim 7, wherein the coupling means consists of a hook which is hooked in the following segment.

9. The sledge according to claim 1, wherein the opening is led centrally in the middle through the segments and is arranged above the central runner.

10. The sledge according to claim 1, wherein the runners are replaceable by wheels, flexible meshes or inflexible blades.
